(19) United States
(12) Patent Application Publication
(10) Pub. No.: US 2012/0327527 A1
(43) Pub. Date: Dec. 27, 2012

(54) METHOD FOR EXTENDING FIELD OF VISION IN A COLLIMATED VISUAL DISPLAY SYSTEM

(76) Inventors: Kevin Jarvis, Shoreham (GB); Terrence Burns, Littlehampton (GB)

(21) Appl. No.: 13/261,396

(22) PCT Filed: Feb. 9, 2011
(86) PCT No.: PCT/GB11/00165

§ 371 Date: Aug. 9, 2012

(30) Foreign Application Priority Data
Mar. 9, 2010 (GB) 1003831.3

(51) Int. Cl. G02B 5/10

(52) U.S. Cl. 359/858

(57) ABSTRACT

A means to increase both vertical and horizontal field of view for collimated display systems suitable for flight simulator display systems that use spherical metallised film mirrors of limited width as a reflecting surface. By joining additional material to both sides (top and bottom) of a length of metallised polymer film, the area of highest quality mirror surface is increased in both the vertical and horizontal directions.

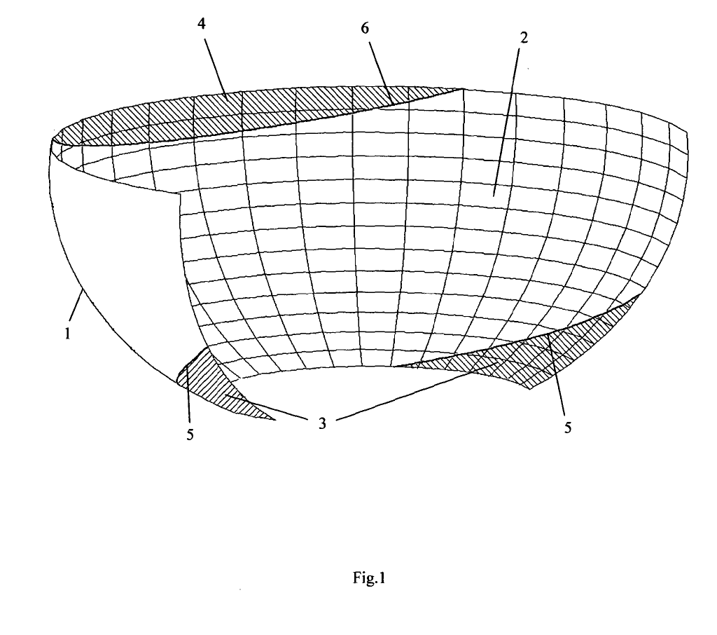

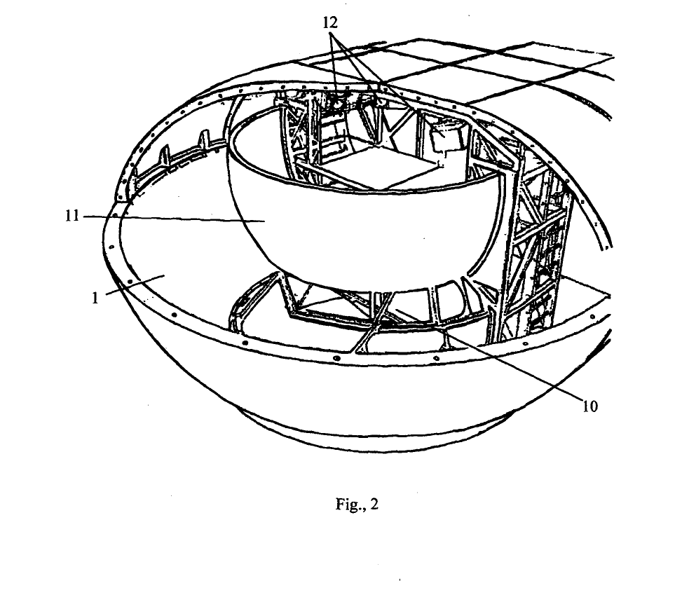

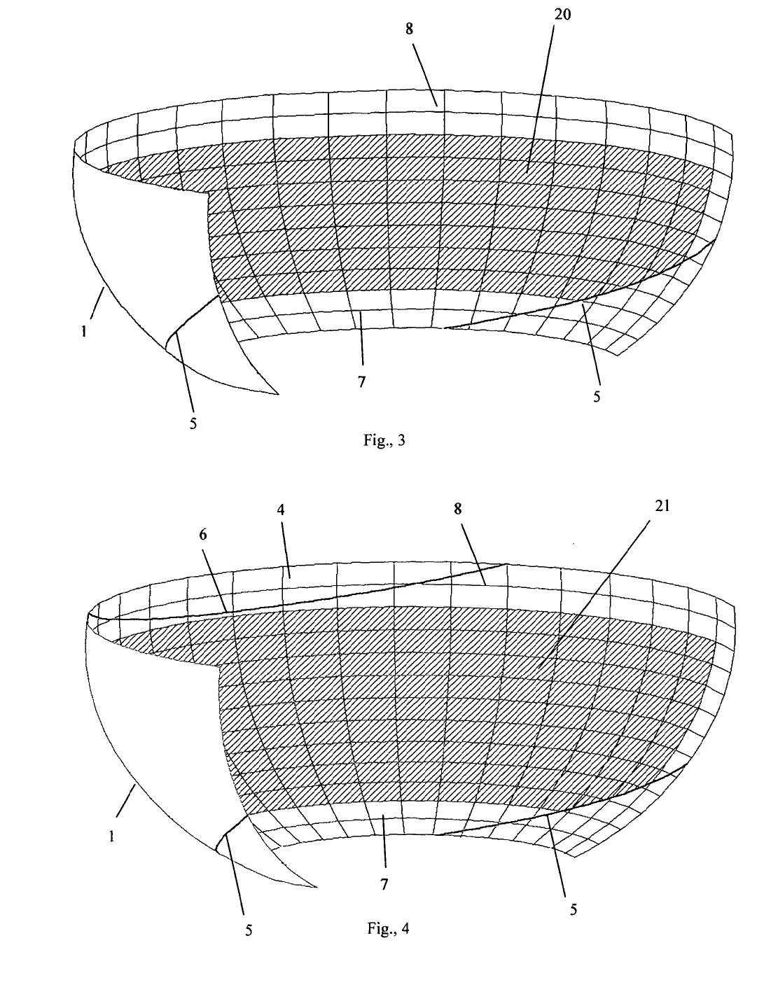

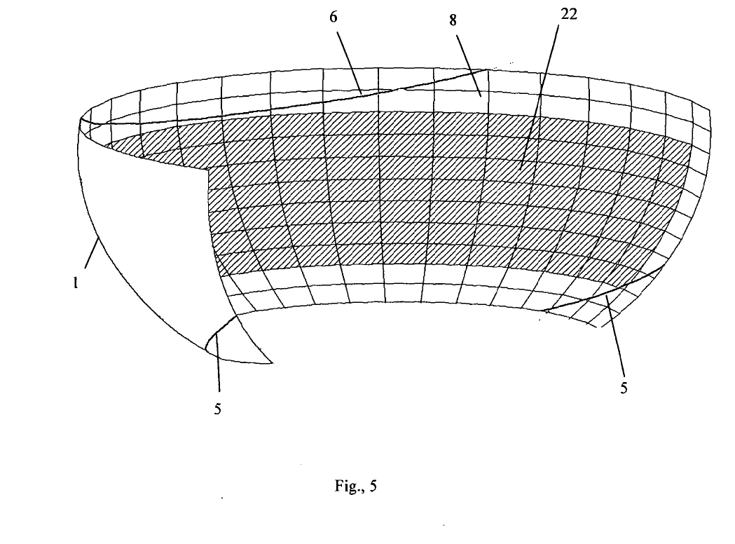

### TECHNICAL FIELD

This invention relates to a method for the application of metallised polymer film in the formation of large curved mirror surfaces used for collimated display systems suitable for flight simulator display systems and other applications where large low cost spherical mirrors are employed such as leisure ride simulators, telescopes or solar collectors.

BACKGROUND ART

Visual display systems typically used on flight simulators where two or more crew members need to see the same representation of the world outside the simulated aircraft make extensive use of film-mirror collimated display systems. Optical collimation through a large almost spherical mirror placed around a simulated aircraft cockpit is known to achieve a realistic presentation of the outside world, by reflecting light from a curved projection screen with the correct optical geometry, to two or more members of the cockpit crew undergoing flight simulation training, or interactively developing aircraft performance and systems. An example of this is illustrated in FIG., 2 showing cockpit 10, mirror 1 and projection screen 11. The spherical mirror is positioned around the cockpit to cover the largest possible field of view whilst reflecting the projected image at near infinite collimation. This arrangement causes light from any point on the projection screen, when viewed from any position within the cockpit area, to arrive at the viewer from the same direction whatever the viewing position. Thus two observers viewing the same point will observe identical images as if they were emanating from a much greater distance than the actual light path to the projection screen. Two light rays between observers and a common object in the display arrive as parallel rays to the observers, and the views are almost identical. This would not be the case if, for example, two pilots sat side by side in a cockpit looking at a display image projected onto a screen only a few metres in front of them. Rays coming from the same point would be seen coming from different directions to each of the pilots and hence each would experience a different scene and positional relationship to the outside world.

The concave collimating mirrors can be made of glass, but more often with a metallised polymer film of polyester, polyethylene or similar material, stretched into a near spherical shape by means of a small differential of air pressure inside a chamber. This chamber supports the mirror film in a shape covering the greatest possible area around the simulated cockpit. The limit of the field of view that can be simulated is dependent on the size of the mirror that can be formed with the polyester film. Film is produced on a roll of considerable length, but of a width limited by the production tools for both fabrication and metallising process. Whilst the available film width is large, there is an economic limit to the maximum width of a roll. The film width therefore governs primarily the vertical field of view available to the simulator crew and also eventually limits horizontal viewing as the spherical shape of the mirror requires the flat film material to be prepared in the form of an annulus. Whilst the film can be joined together in sections using various splicing techniques, the optical collimating quality is not maintained across a join. This results in a discontinuation of the observed image at the region of any join that is generally not acceptable for realistic visual simulation applications.

### DISCLOSURE OF INVENTION

One technique is known for extending metallised film by joining two pieces onto the lower outer edges. This allows the extension of the film vertically or horizontally but is normally limited at the join, resulting in loss of view at the lower outer corners of the display.

The technique described in this invention relates to joining a piece of film to the top of a mirror in addition to the outer edges in order to further increase field of view. Joining film to the top of the mirror is not an obvious means of increasing field of view when the join itself cannot form a part of the visible area of the mirror. However, because the edges of the mirror are attached to the chamber preventing the film from stretching uniformly in all directions, the film does not form a true spherical surface near to the boundary of the mirror. This results in the mirror having a dead-band along the top and bottom that cannot be used for viewing from the cockpit. The mirror therefore has to extend above and below the visible area necessary to view the projected image. Adding a piece of film material to the top of the mirror therefore forms a narrow curved segment along the top. By keeping this segment within the dead-band width, then all of the increase due to the added film contributes to increasing the visible field of view in the useable area of the total mirror.

### BRIEF DESCRIPTION OF DRAWINGS

An embodiment of the invention is now described with reference to the accompanying drawings.

FIG., 1. Illustrates a spherical mirror 1, composed of 3 pieces of film material 2,3 & 4. The lower outer edges 5 and upper edge 6 of the main film sheet 2 are used to join lower film sections 3 and upper section 4.

FIG., 2. Illustrates, in a cut-away view, the main components of a typical collimating display system, namely: Collimating Mirror 1, Rear Projection Screen 11 and Projectors 12. All these are shown in relation to a flight simulator cockpit 10. The outer enclosure is shown cut-away to expose the above components within. The image on the projector screen is typically formed by transmitting a combined image through the screen 11 from multiple projectors 12.

FIG., 3. Illustrates the useable area 20 achievable with joins 5 in the lower and outer edges of the film only. The visible area is the space between the two dead bands at top 8 and bottom 7 of the total film area 1.

FIG., 4. Illustrates the increase in vertical field-of-view from the increased useable area 21 achievable with joins 5 in the lower and outer edges of the film and also the upper join 6 that is contained completely within the upper dead band 8.

FIG., 5. Illustrates the increase in horizontal field-of-view from the useable area 22 when the vertical field-of-view remains the same after an upper join 6 has been applied.

### BEST MODE FOR CARRYING OUT THE INVENTION

claim 1 of this invention is illustrated by comparing FIG., 3 and FIG., 4, showing that the useable area 21 in FIG., 4 that is achieved using the upper join 6 is significantly increased over the useable area 20 shown in FIG., 3. By joining a segment of film 4 to the top edge 6 of the mirror, the increase of film width takes place entirely within the dead band 8 which does not form any of the useable portion of the mirror 21. The resulting increase in usable area and hence increase in visible vertical field-of-view to the pilot is equal to the width of the dead band.

The effect of adding film material to the top of the mirror may be used to extend the horizontal field of view. It can be seen, by comparing FIG., 5 with FIG., 3, that when additional film is added to the top edge 6 of the mirror 1 within the dead band 8, then the horizontal width of the useable mirror area 22 is increased because the lower edge joins 5 are lowered, reducing horizontal field of view restrictions at the lower edges of the display. Horizontal field-of-view available is therefore increased supporting claim 2.

1. A method of increasing the vertical field-of-view of a simulated collimated visual display by means of joining an additional piece of reflecting film mirror material to the upper mirror edge, within an unused area known as the dead band. The term “dead-band” is well known within the visual simulator industry in relation to large collimating mirrors constructed from metallised film, and defines a boundary area adjacent to a film attachment surface where the optical quality of the mirror is not considered to be of useable quality.

2. A means of increasing horizontal field of view of a simulated collimated visual display by means of joining an additional piece of reflecting film mirror material to the upper mirror edge, within an unused area known as the dead band as referred to in claim 1.
